(19) United States
(12) Patent Application Publication
(10) Pub. No.: US 2011/0154974 A1
(43) Pub. Date: Jun. 30, 2011

(54) Drum stick

(76) Inventor: Nicholas Carelli, Kerhonkson, NY (US)

(21) Appl. No.: 12/655,289

(22) Filed: Dec. 28, 2009

(51) Int. Cl. G10D 13/02

(52) U.S. Cl. 84/422.4

(57) ABSTRACT

A Drum Stick having two tapered portions, wherein one tapered portion is tapered towards one end of the drum stick and the other tapered portion is tapered towards the other end of the drumstick, permits flexibility in rhythm and striking force.

### FIELD OF THE INVENTION

This invention relates to a musical instrument accessory, particularly a stick for playing drums.

### BACKGROUND OF THE INVENTION

As noted by Cordes, the “conventional wooden drum stick . . . is comprised of a one-piece wooden stick having a main cylindrical body portion and a forward end portion which is gradually tapered down to a reduced diameter neck portion before terminating in an enlarged tip.” (U.S. Pat. 3,722,350 issued Mar. 27, 1973)

And, as stated by Harrison, “Conventional drumsticks generally are made of wood and have a round or cylindrical configuration with an elongate, round, or cylindrical handle or gripping means at one end thereof and a striking tip at the other end. (U.S. Pat. No. 3,893,364 issued Jul. 8, 1975)

Furthermore, as summarized by Amendola, “Drum sticks have a generally cylindrical geometry with varying degrees of taper. A drum stick typically has a bead or ball at its distal end. The bead or ball is normally used to strike a tympanic surface or other part of a drum. However, any part of the drum stick may be used to elicit percussive sound from a drum or other object.” (U.S. Pat. No. 5,170,001 issued Dec. 8, 1992)

### OBJECTS OF THE INVENTION

An object of the present invention is to provide a drum stick which is more comfortable to use.

A further object of the present invention is to enable a drummer to use any grip position to provide a variable rhythm and striking force.

### SUMMARY OF THE INVENTION

In the present invention, a drumstick comprises two tapered portions aligned along a common axis. The first tapered portion tapers toward the first end of the drumstick and the second tapered portion tapers toward the second end of the drumstick. The first end of the drumstick of the present invention comprises a first tip and the second end of the drumstick of the present invention comprises a second tip.

In another embodiment of the present invention, a drumstick further comprises a grip portion positioned between said two tapered portions, wherein the two taper portions and the grip portion are aligned along a common axis.

In a preferred embodiment of the present invention, a drumstick is made from a single piece of material.

In other embodiments of the present invention, the portions of a drumstick are modular and assembled so as to be aligned along a common axis.

In other embodiments of the present invention the first end of a drumstick is removably attachable to the first tapered portion of said drumstick.

In other embodiments of the present invention the second end of a drumstick is removably attachable to the second tapered portion of said drumstick.

In a preferred embodiment of the present invention, a drumstick in made of wood.

In other embodiments of the present invention, a drumstick is made from at least one suitable material.

A tip of the drumstick of the present invention may have any shape. For example, the shape of a tip may be blunt or rounded. Furthermore, the tip may be customized to the desire of the user and therefore may be styled in any manner selected by the user.

### BRIEF DESCRIPTION OF THE DRAWINGS

FIG. 1 illustrates side elevations of conventional drum sticks.

FIG. 2 illustrates the portions of conventional drum sticks.

FIGS. 3a, 3b and 3c illustrate side elevations of the drumsticks of the invention.

FIG. 4 illustrates variations of the drumsticks of the invention.

### DETAILED DESCRIPTION OF THE INVENTION

In order to illustrate and describe the details of the invention and to distinguish the invention from the prior art, reference will now be made to the drawings.

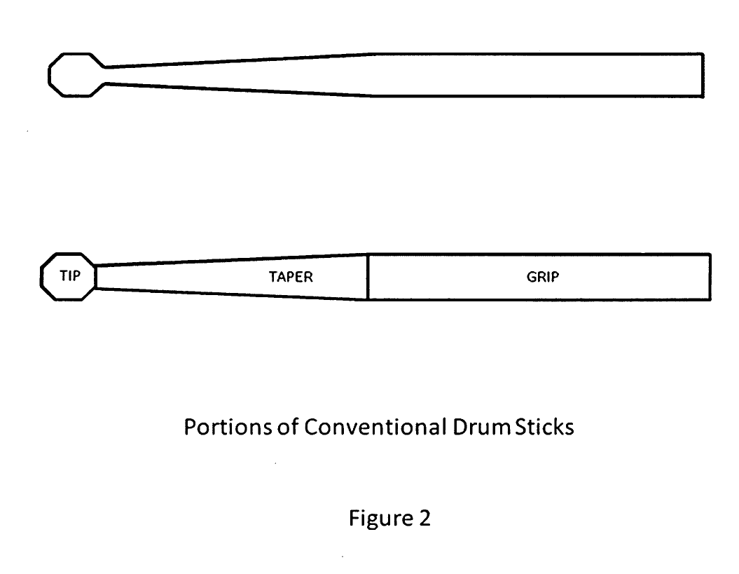

As illustrated in FIG. 2, a conventional drum stick comprises a grip portion, a taper portion, and two ends. The prior art also refers to the grip as the handle. And, the end of the handle is often referred to as the butt end of a drum stick. The grip or handle is not tapered in conventional drum sticks. The other end of a drum stick is typically referred to as the striking end of the drum stick. The taper portion of a conventional drum stick tapers toward the striking end of the drum stick. And, the striking end comprises a tip. Thus, the taper narrows from a base which is contiguous with the handle to an apex which is contiguous with a tip.

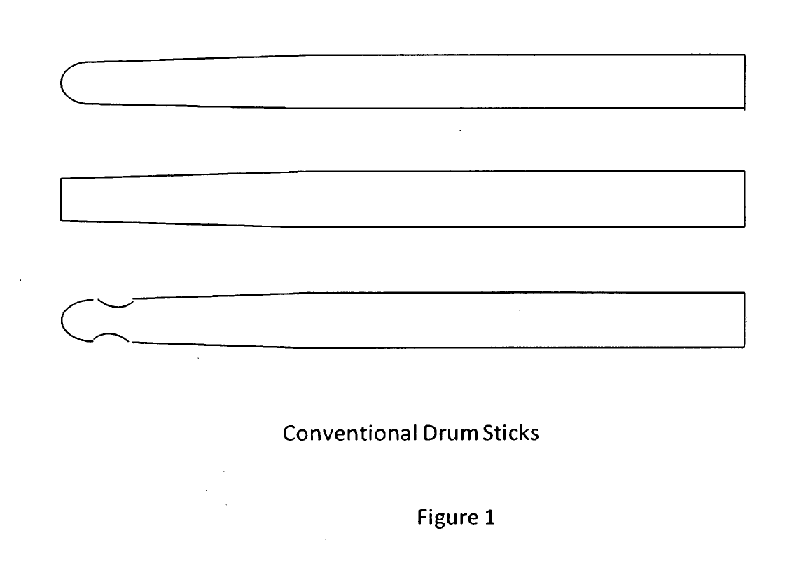

The octagonal tip in FIG. 2 is for illustration only. The actual tip may be of any size and shape suitable for striking a drum head or other musical apparatus. Some of the striking ends of conventional drumsticks are illustrated in FIG. 1. FIG. 1 illustrates a taper portion ending in a smooth curved end, wherein the smooth curved end of the taper is the tip and the striking end of the drumstick. FIG. 1 also illustrates a taper portion having a truncated end, wherein the truncated end of the taper is the tip and striking end of the drumstick. And, furthermore, FIG. 1 illustrates a taper portion which narrows toward and becomes contiguous with a stylized tip, wherein the taper ends at its junction with the stylized tip and an end of the stylized tip is the striking end of the drumstick.

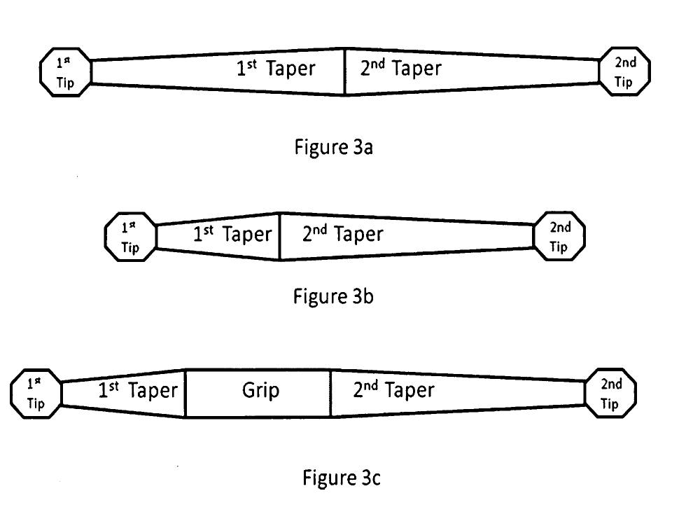

FIGS. 3a, 3b and 3c illustrate the invention. As illustrated in FIG. 3a, the invention comprises two taper portions and two striking ends. Preferably, the two taper portions and the two ends are aligned along a common axis. Each taper portion tapers toward an end of the drum stick. Thus, the drumstick comprises a first taper portion, a second taper portion, a first end and a second end, wherein said first taper portion tapers toward said first end and said second taper portion tapers toward said second end and each said end comprises a tip.

The illustration of FIG. 3b represents a preferred embodiment wherein the length of the second taper portion is twice the length of the first taper portion. This design changes the weight distribution of the drum stick. This design also allows the user to change the balance of the drum stick during use. This provides additional flexibility compared to a conventional drum stick.

The illustration of FIG. 3c represents an embodiment wherein a grip is interposed between the two taper portions. In this embodiment, preferably, the two taper portions, the grip and the two ends are aligned along a common axis.

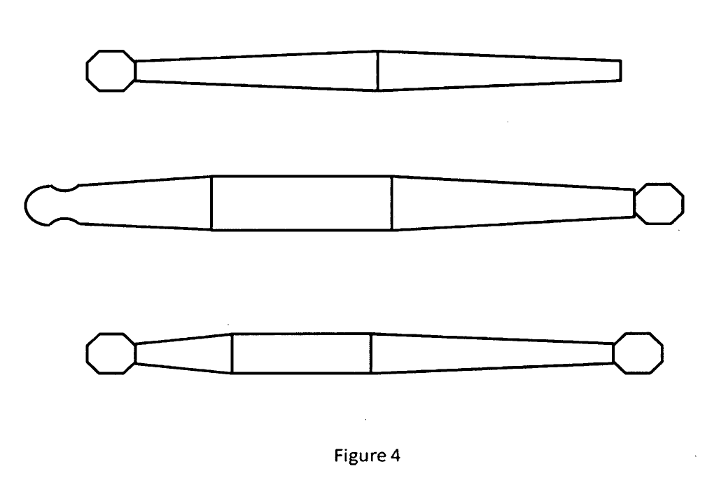

FIG. 4 illustrates some of the variations of the invention. A grip is an optional feature of the invention. Although in a preferred embodiment of the invention the ratio of the lengths of the two taper portions is 2:1, the ratios of the lengths of the two taper portions may vary and will depend on the user and use of the drum stick. And, the two tips of a drum stick of the invention may be the same size and shape or may differ in size and shape.

While the invention has been described in detail herein in accordance with certain preferred embodiments thereof, many modifications and changes therein may be effected by those skilled in the art. Accordingly, it is intended by the appended claims to cover all such modifications and changes as fall within the spirit and scope of the invention.

What is claimed is:

1. A drumstick comprising a first taper portion, a second taper portion, a first end and a second end, wherein said first taper portion tapers toward said first end, said second taper portion tapers toward said second end and each end comprises a tip; and, wherein the length of one taper portion is twice the length of the other taper portion.

2. A drumstick comprising a first taper portion, a second taper portion, a first end and a second end, wherein said first taper portion tapers toward said first end, said second taper portion tapers toward said second end and each end comprises a tip.
